(19) United States
(12) Patent Application Publication
(10) Pub. No.: US 2005/0038807 A1
(43) Pub. Date: Feb. 17, 2005

(54) Method of modifying an educational grade book to incorporate standardized testing criteria

(76) Inventor: Bettina Young, Boynton Beach, FL (US)

Correspondence Address: Michael A. Slavin;McHale & Slavin, P.A., 2855 PGA Blvd., Palm Beach Gardens, FL, 33410, US

(21) Appl. No.: 10/640,864

(22) Filed: Aug. 13, 2003

(51) Int. Cl. G06F 7/00

(52) U.S. Cl. 707/102

(57) ABSTRACT

The instant invention relates to a method of modifying an educational grade book to reflect standardized testing criteria, which may be used by teachers or professors for personalization of a grade book. The method generally utilizes a laminated label kit having a construction which includes a label sheet and a carrier sheet. The label sheet is generally die cut to form a plurality of labels while the carrier sheet acts as a carrier to which the labels are removably secured. The labels include a first indicia side for carrying standardized testing criteria indicia and a second adhesive side to which a pressure sensitive adhesive is applied.

### FIELD OF THE INVENTION

This invention relates to a method of modifying an educational grade book; particularly to a grade book modification kit containing a plurality of preprinted adhesive backed labels in an organized arrangement which are adapted for use with standard educational grade books.

### BACKGROUND OF THE INVENTION

Some states, including Florida, have established performance standards which must be satisfied by students before they may advance to the next academic level. Teachers in these states face the difficult challenge of organizing the teaching curriculum into a syllabus used to implement the required student achievement programs. Laying out the syllabus requires the teacher to evaluate all of the requirements with regard to available teaching time. The syllabus generally outlines a particular time frame in which the required information will be taught.

Grade keeping involves the scoring of a students assignments or participation in required studies. Once the assignments or activities are completed and analyzed by an instructor, the scores are transferred to the grade book. The accurate transfer of the scores from the source class work to the target grade book is generally achieved by manual insertion into a grid-like sheet. However, the manual transfer of grades becomes more difficult to control with larger classrooms and performance based standards for students. The sheer volume of information needed to be organized and recorded requires the teacher to modify his or her grade book for proper implementation of these requirements.

Typically a teacher modifies a standard grade book to function as a syllabus for the required state standards by hand writing notes in the upper portion of each page. Often the space required to write the standards into the grade book is insufficient and forces the instructor to abbreviate or crowd the text. Due to the similarities between the standards text, hand writing in the standards may cause instructors to misread the grade book and misplace or incorrectly record a students achievements.

Therefore what is needed in the art is a method and kit for personally customizing a standard grade book into a syllabus which reflects standardized testing criteria. The system should be simple to use and modify, and should include the standards required for a particular state.

### SUMMARY OF THE INVENTION

The objectives are accomplished in accordance with the invention by the provision of a kit of precut and preprinted pressure sensitive adhesive labels releasably adhered to a liner sheet. The labels are preprinted with indicia specifically relating to standardized testing criteria, e.g. conduct, reading, writing, listening/viewing/speaking, math and social science, as well as organizational and safety information, e.g. assignment number/date, and parental contact information. The labels are positioned on the liner in a adjacent relationship according to subject matter. The labels have a generally rectangular precut shape and size which approximates the column header space provided for a two week period in a standard grade book. The labels are removed from the liner to expose the pressure sensitive adhesive. The exposed pressure sensitive adhesive is adhered to a grade book page to create a bond between the label and the paper. The labels may be quicky arranged to suit a particular teachers' syllabus. The construction of the labels allow a second label to be placed directly over the top of a first label where modification of an existing syllabus is desired.

Adhesive labels are well known in the art and various types of laminated label constructions have been employed to provide a user with labels that can be attached to various types of substrates such as documents, pages in a magazine, message boards and the like. Typically, such laminated constructions are made of two plies, one of which is die-cut to form a plurality of labels while the other acts as a carrier sheet to which the die-cut sheet is peelably secured so that the die-cut labels can be removed from the carrier sheet and applied to a substrate.

In order to be applied to a substrate, an adhesive is applied to the back of each label. The adhesive is of a type that releases from the carrier sheet while remaining on the label. Various types of barrier coatings have also been provided on the carrier sheet to allow release of the labels with sufficient adhesive on their backs allow the labels to be applied to a substrate.

By utilizing the aforementioned construction, the preprinted labels can be easily and quickly attached to the pages of a grade book to set up a personalized system to manage performance based grades for every grade level.

Accordingly, a primary objective of the instant invention is to teach a laminated sheet for supplying a plurality of removable precut labels which are preprinted with standardized testing criteria, each of which can be easily handled and subsequently affixed to a standard grade book page.

Another objective of the instant invention is to teach a method for setting up a personalized grade book to manage performance based grades for every grade level.

Yet another objective of the instant invention is to teach a label kit for improving grade book clarity to overcome the problems associated with conventional grade transfer techniques.

Still another objective of the instant invention is to teach a method for simplifying grade recording procedures in those states, such as Florida, which have standardized testing criteria, namely the Florida Comprehensive Achievement Test.

Other objectives and advantages of this invention will become apparent from the following description taken in conjunction with the accompanying drawings wherein set forth, by way of illustration and example, certain embodiments of this invention.

The drawings constitute a part of this specification and include exemplary embodiments of the present invention and illustrate various objectives and features thereof.

### BRIEF DESCRIPTION OF THE DRAWINGS

FIG. 1 is a front view illustrating the preferred labels utilized in the instant invention;

FIG. 2 is a front view of a grade book page utilized in the instant invention;

FIG. 3 is a front view of a grade book page utilized in the instant invention;

FIG. 4 is a front view of a grade book page illustrating labels of the instant invention secured within the preferred placement area of a grade book page;

FIG. 5 is a front view of a grade book page illustrating labels of the instant invention secured within the preferred placement area of a grade book page;

### DETAILED DESCRIPTION OF THE PREFERRED EMBODIMENT

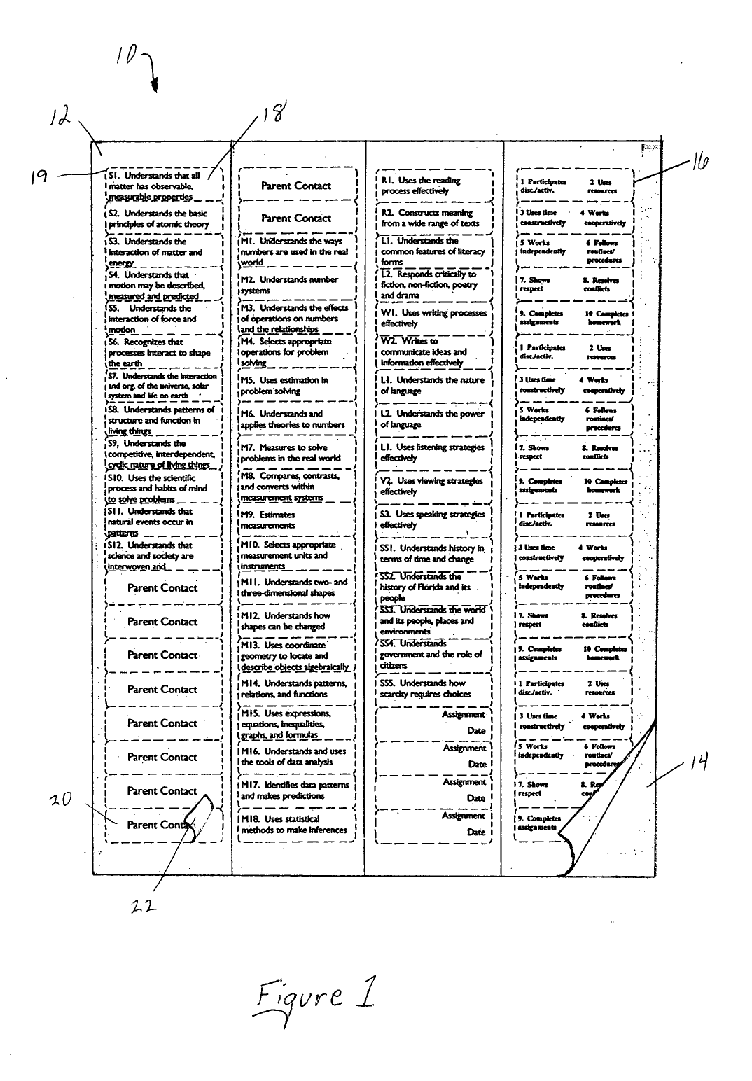

Referring to FIGS. 1-5, illustrated is the grade book modification kit of the present invention. The modification kit 10 generally utilizes a laminated label construction made up of a label sheet 12 and a carrier sheet 14. The label sheet 12 is generally die cut 16 to form a plurality of labels 18 while the carrier sheet 14 acts as a carrier to which the labels 18 are removably secured. The labels 18 include a first indicia side 20 for carrying the standardized testing criteria indicia and a second adhesive side 22 to which a pressure sensitive adhesive is applied. Pressure sensitive adhesives which are of a type to be peeled from the carrier sheet while remaining on the label are well known in the art. Various types of barrier coatings, which are also well known in the art, have been provided on a carrier sheet to allow release of the labels with sufficient adhesive on the backs of the labels to allow the labels to be applied to a substrate. It should be noted that while the self-adherent articles are depicted as labels 18, it is understood that the term label is exemplary and it is within the purview of the instant invention to substitute various tapes, stamps, transfers or the like. It should also be noted that while the illustrated labels are white with black imprinted indicia, the labels and the indicia may be any suitable color.

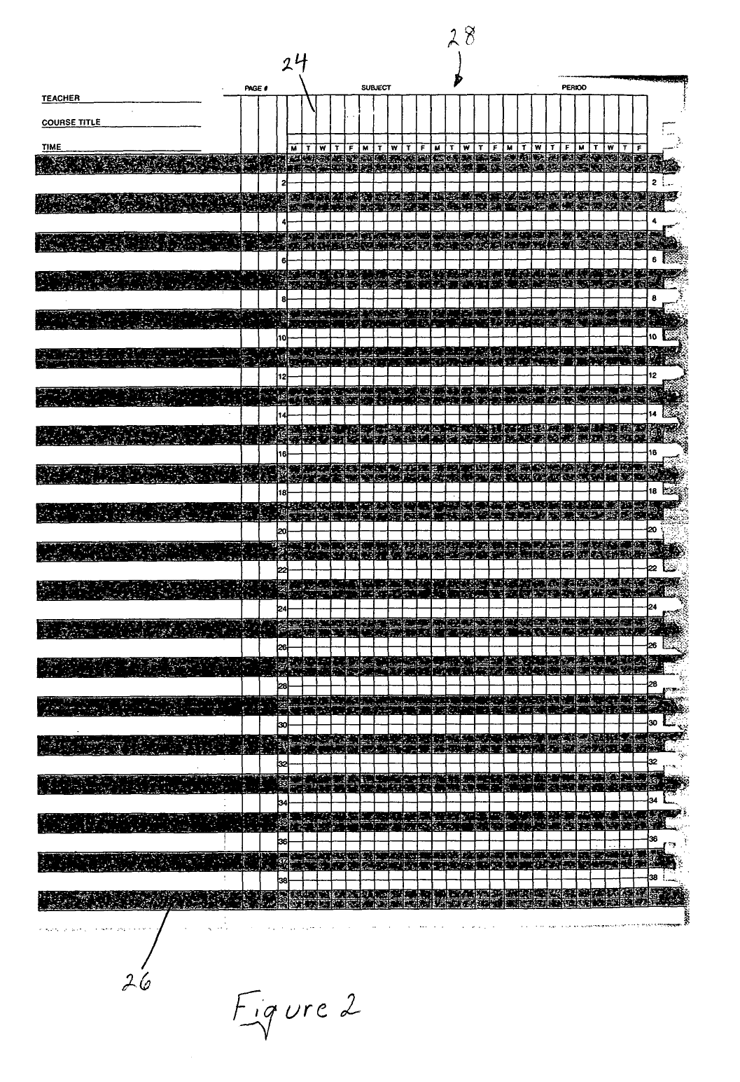

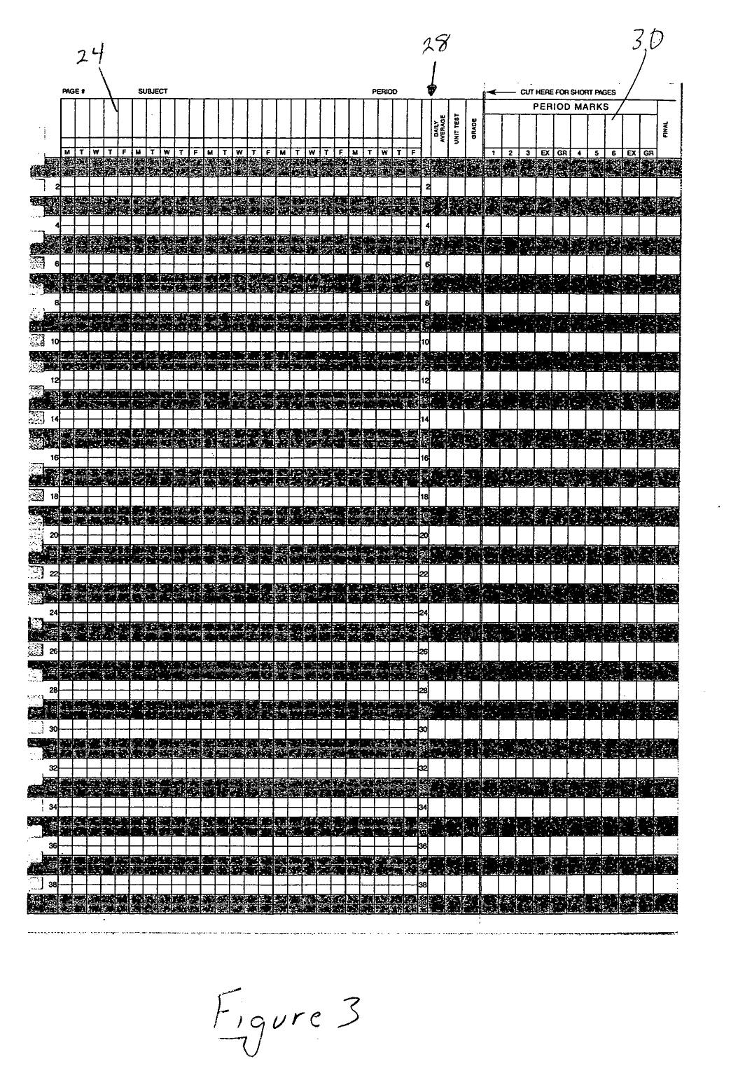

In the preferred embodiment the labels are die cut to have a generally rectangular shape and generally sized to fit in the column heading spaces 24 provided on the pages 28 of a standard educational grade book, such as those shown in FIGS. 2 and 3. In a most preferred embodiment the corners of the label 18 are provided with corner radii 19 to minimize “dog earing” of the labels during use. It should also be noted that while the labels 18 shown and described in the instant invention are preferably rectangular, they can be made in any suitable shape including but not limited to oval, square, or circular.

The first indicia side 20 of each label 18 includes at least one standardized testing criteria indicia imprinted thereon. For example, Florida has standardized testing criteria relating to student conduct, reading, writing, listening/viewing/speaking, math, and social science (FIG. 1). Other types of label indicia useful for grade book organization and/or safety may also be provided which may include but should not be limited to assignment number, date of assignment, and parental contact information. It should also be noted that while the indicia is exemplified as being printed on the exemplary labels, such indicia may be combined with the substrate carrier in any manner known in the art, e.g. embossed, impregnated, laser enhanced, holographic indicia, hidden in a manner to prevent counterfeiting, or the like.

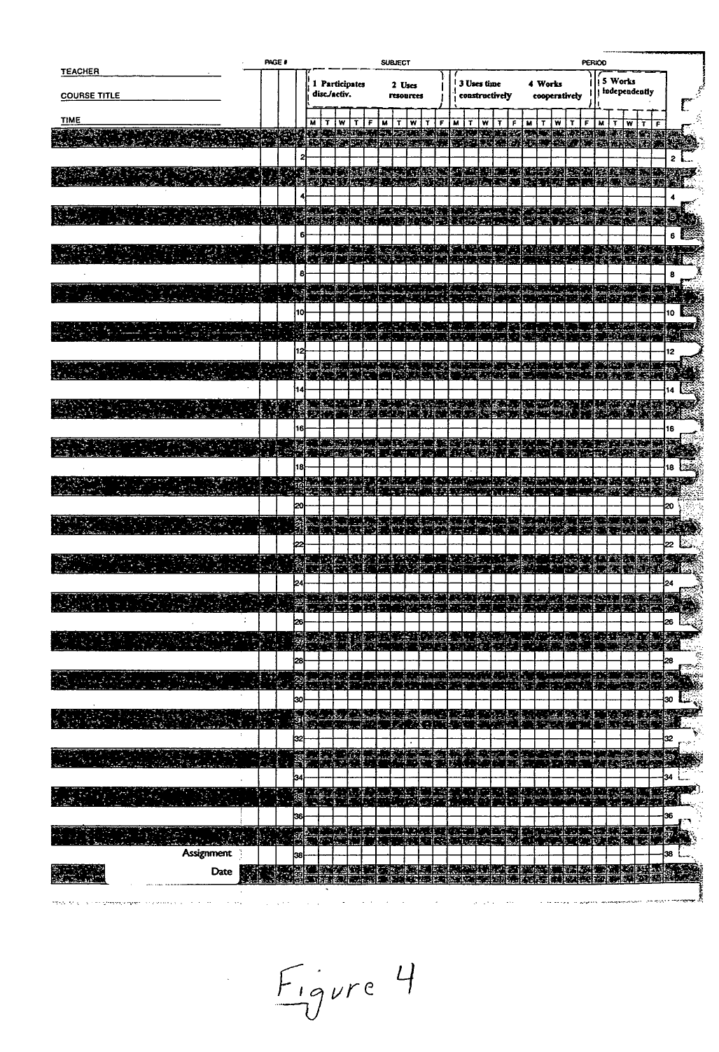

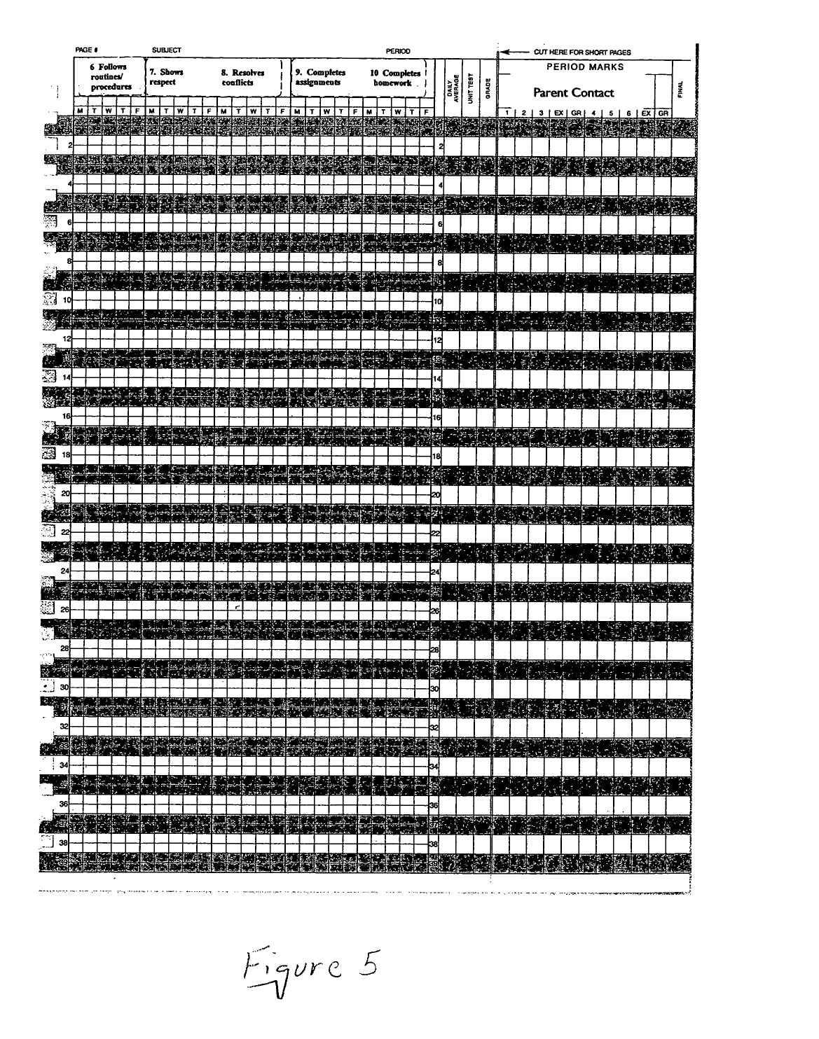

In operation, the teacher selects the attendance pages 28 from a standard grade book such as those produced by Alvah M. Squib Company of McKeesport, PA. 15134-0428. Preferably, the conduct labels numbered one through ten (FIG. 1) are peeled from the backing sheet and secured within the column heading area 24 of the first two selected pages 28, noting that it may be necessary to cut labels five and six in half for proper placement (FIGS. 4 and 5). On the next two selected pages 28 the reading labels R1, R2, L1, L2 (FIG. 1) are preferably secured within the column heading areas 24. The writing labels W1, W2, L1, L2 (FIG. 1) are preferably secured within the column heading area 24 on the following two selected pages 28. The selected math labels (FIG. 1) are preferably secured within the column heading area 24 of the following two selected pages 28. The selected social science labels (FIG. 1) are preferably secured within the column heading area 24 of the following two selected pages 28. Optional labels such as the parent contact label (FIG. 1) may be secured throughout the grade book. These labels are preferably secured on the pages 28 within the column heading area 30 titled “Period Marks” (FIG. 3). The assignment/date labels may also be affixed throughout the grade book and is preferably positioned in the bottom left corner area 26 of the grade book pages (FIG. 2).

Referring to FIGS. 4 and 5, a portion of the labels 18 are shown in a preferred placement within the pages 28 of a standard grade book. It should be noted that the illustrated placement is a non-limiting embodiment, and it is within the purview of the instant invention to place the labels at any position or orientation within the grade book pages suitable for teacher use.

The invention thus provides a modification kit and a method for use adapted for a standard grade book, which may be used by teachers or professors for personalization of a grade book with respect to standardized testing criteria.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A method for modifying a grade book to incorporate standardized testing criteria comprising:
supplying an educational grade book, said grade book including a plurality of pages, said pages including a plurality of horizontal column indicia imprinted thereon, said horizontal columns adapted for writing in student names, said pages including a plurality of vertical columns, said vertical columns providing for a plurality of school days, said vertical columns adapted for writing in student grades, said vertical columns including a column header area, said column header area adapted for writing in student requirements, wherein writing student requirements in said column header area provides a class syllabus for a specified class term;
supplying a releasable label sheet comprising a label stock having a first indicia side and a second side coated with pressure sensitive adhesive, and a release sheet having at least one side coated with a release agent, said pressure sensitive adhesive engaging said release sheet coated surface, said first indicia side of said label sheet having at least one standardized testing criteria indicia imprinted thereon;
removing said label sheet from said release sheet, whereby said pressure sensitive adhesive remains on said label sheet upon removal of said label sheet from said release sheet;
adhering said exposed second adhesive side of said label sheet to said column header area of said grade book page, whereby said grade book is modified to contain said standardized test criteria.

2. The method of modifying a grade book as described in claim 1, wherein said label sheet is die cut into one or more sections to define a plurality of removable labels in said label sheet.

3. The method of modifying a grade book as described in claim 2 wherein said die cut labels are generally rectangular in shape and generally sized to fit in said column header spaces provided in said educational grade book.

4. The method of modifying a grade book as described in claim 3 wherein at least one corner of said die cut rectangular label sections include corner radii.

5. The method of modifying a grade book as described in claim 3 wherein said die cut labels are about one half inch by about one and three quarters inches in size.

6. The method of modifying a grade book as described in claim 1 wherein said releasable label sheet includes embossing thereon.

7. The method of modifying a grade book as described in claim 1 wherein said releasable label sheet includes holographic indicia thereon.

8. The method of modifying a grade book as described in claim 1 wherein said releasable label sheet is color coded for visual distinction.

9. The method of modifying a grade book as described in claim 1 wherein said imprinted standardized testing criteria indicia is color coded for visual distinction.

10. The method of modifying a grade book as described in claim 2 wherein said die cut labels are generally round in shape and generally sized to fit in the space provided in said vertical column header area of said educational grade book.

11. The method of modifying a grade book as described in claim 2 wherein said die cut labels are generally oval in shape and generally sized to fit in the space provided in said vertical column header area of said educational grade book.

12. The method of modifying a grade book as described in claim 1 wherein said at least one standardized test criteria indicia imprinted on said label is selected form the group consisting of student conduct, reading, writing, listening, viewing, speaking, mathematics, and social science.

13. The method of modifying a grade book as described in claim 1 wherein said method includes at least one label having standardized testing criteria indicia imprinted thereon relating to student conduct, and at least one label having standardized testing criteria indicia imprinted thereon relating to reading, and at least one label having standardized testing criteria indicia imprinted thereon relating to writing, and at least one label having standardized testing criteria indicia imprinted thereon relating to listening, viewing and speaking, and at least one label having standardized testing criteria indicia imprinted thereon relating to mathematics, and at least one label having standardized testing criteria indicia imprinted thereon relating to social science.

14. The method of modifying a grade book as described in claim 1 wherein said method includes about twelve labels having different standardized testing criteria indicia imprinted thereon relating to student conduct, and about four labels having standardized testing criteria indicia imprinted thereon relating to reading, and about two labels having standardized testing criteria indicia imprinted thereon relating to writing, and about five labels having standardized testing criteria indicia imprinted thereon relating to listening, viewing and speaking, and about eighteen labels having standardized testing criteria indicia imprinted thereon relating to mathematics, and about five labels having standardized testing criteria indicia imprinted thereon relating to social science.

15. The method of modifying a grade book as described in claim 1 wherein said standardized testing criteria relates the Florida Comprehensive Achievement Test.

16. An kit for modifying an educational grade book to reflect standardized testing criteria comprising:
an educational grade book, said grade book including a plurality of pages, said pages including a plurality of horizontal column indicia imprinted thereon, said horizontal columns adapted for writing in student names, said pages including a plurality of vertical columns, said vertical columns providing for a plurality of school days, said vertical columns adapted for writing in student grades, said vertical columns including a column header area, said column header area adapted for writing in student requirements, wherein writing student requirements in said column header area provides a class syllabus for a specified class term;
a releasable label sheet comprising a label stock having a first indicia side and a second side coated with pressure sensitive adhesive, and a release sheet having at least one side coated with a release agent, said pressure sensitive adhesive engaging said release sheet coated surface, said first indicia side of said label sheet having at least one standardized testing criteria indicia thereon;
whereby said label sheet is removable from said release sheet and whereby said pressure sensitive adhesive remains on said label sheet upon removal of said label sheet from said release sheet and whereby said exposed second adhesive side of said label sheet is adhered to said column header area of said grade book page, whereby said grade book is modified to contain said standardized test criteria.

17. The kit for modifying an educational grade book as described in claim 15 wherein said label sheet is die cut into one or more sections to define a plurality of removable labels in said label sheet.

18. The kit for modifying an educational grade book as described in claim 16 wherein said die cut labels are generally rectangular in shape and generally sized to fit in said column header spaces provided in said educational grade book.

19. The kit for modifying an educational grade book as described in claim 17 wherein at least one corner of said die cut rectangular label sections include corner radii.

20. The kit for modifying an educational grade book as described in claim 15 wherein said at least one standardized test criteria indicia imprinted on said label is selected form the group consisting of student conduct, reading, writing, listening, viewing, speaking, mathematics, and social science.

21. The kit for modifying an educational grade book as described in claim 15 wherein said method includes at least one label having standardized testing criteria indicia imprinted thereon relating to student conduct, and at least one label having standardized testing criteria indicia imprinted thereon relating to reading, and at least one label having standardized testing criteria indicia imprinted thereon relating to writing, and at least one label having standardized testing criteria indicia imprinted thereon relating to listening, viewing and speaking, and at least one label having standardized testing criteria indicia imprinted thereon relating to mathematics, and at least one label having standardized testing criteria indicia imprinted thereon relating to social science.

22. The kit for modifying an educational grade book as described in claim 15 wherein said method includes about twelve labels having different standardized testing criteria indicia imprinted thereon relating to student conduct, and about four labels having standardized testing criteria indicia imprinted thereon relating to reading, and about two labels having standardized testing criteria indicia imprinted thereon relating to writing, and about five labels having standardized testing criteria indicia imprinted thereon relating to listening, viewing and speaking, and about eighteen labels having standardized testing criteria indicia imprinted thereon relating to mathematics, and about five labels having standardized testing criteria indicia imprinted thereon relating to social science.

23. The kit for modifying an educational grade book as described in claim 15 wherein said standardized testing criteria relates to the Florida Comprehensive Achievement Test.
